(19) United States
(12) Patent Application Publication
(10) Pub. No.: US 2008/0307882 A1
(43) Pub. Date: Dec. 18, 2008

(54) Capacitive Level Probe

(76) Inventors: Holger Schroter, Morsum (DE); Kerstin Borchers, Bremen (DE); Andreas Kulman, Bremen (DE)

Correspondence Address: WOOD, HERRON & EVANS, LLP, 2700 CAREW TOWER, 441 VINE STREET, CINCINNATI, OH, 45202, US

(21) Appl. No.: 11/915,911

(22) PCT Filed: Jun. 2, 2006
(86) PCT No.: PCT/EP06/05300

§ 371 Date: May 20, 2008

(30) Foreign Application Priority Data
Jun. 3, 2005 (DE) 10 2005 025 576.0

(51) Int. Cl. G01F 23/26

(52) U.S. Cl. 73/304 C

(57) ABSTRACT

The invention concerns a capacitive level probe, in particular for measuring the filling height of a liquid medium, comprising a connection portion (14), an electrode (12) which is connected to the connection portion (14) and which projects beyond the connection portion (14) and which includes a sensor element (28), an insulating sleeve (16) which radially completely surrounds the sensor element (28), wherein the insulating sleeve (16) bears against the electrode (12) in a contact region (30), and wherein the electrode (12) and the insulating sleeve (16) are so designed that gas (56) present in the contact region (30) flows out of the contact region (30) on a flow path (51) out of the contact region (30) upon a pressure drop between the contact region (30) and the area surrounding the level probe (10). In accordance with the invention the insulating sleeve (16) is so designed that the flow path extends through at least one opening (32) in the insulating sleeve (16) or completely between the electrode (12) and the insulating sleeve (16). The invention further concerns a container for liquid medium having a level probe of that kind.

The invention concerns a capacitive level probe, in particular for measuring the filling height of a liquid medium, comprising: a connection portion, an electrode which is connected to the connection portion and which projects beyond the connection portion and which includes a sensor element, an insulating sleeve which radially completely surrounds the sensor element, wherein the insulating sleeve bears against the electrode in a contact region and wherein the electrode and the insulating sleeve are so designed that gas present in the contact region flows out of the contact region on a flow path out of the contact region upon a pressure drop between the contact region and the area surrounding the level probe.

In accordance with a further aspect the invention concerns a container for liquid medium.

Capacitive level probes are known for measuring the filling height of liquid medium. For that purpose an electrode of the level probe projects into a container in which the filling height of the liquid medium is to be determined. In that case the length of the electrode is generally so selected that the liquid medium just wets the electrode when the lowest possible filling level is reached and the electrode is substantially completely wetted when the liquid medium is at the highest possible filling level.

The electrode is electrically insulated from the surrounding area. The electrode therefore forms with the surrounding area a capacitor whose capacitance depends on the one hand on the geometry of the surrounding area and the electrode. On the other hand the capacitance of the capacitor formed by the electrode and the surrounding area depends on the dielectric constant of the surrounding area. Most liquid media have a dielectric constant which is markedly greater than one. When therefore the medium reaches the highest possible filling level the electrode is for a large part surrounded by liquid medium with a high dielectric constant. That affords a high capacitance. If in contrast the filling level if low, that affords a lower capacitance. If therefore, with a given geometry in respect of the electrode and the container, the dielectric constant of the liquid medium does not change, the filling height of the liquid medium can be ascertained from the capacitance of the capacitor formed by the electrode and the surrounding area.

So that the capacitance can be measured it is necessary for the electrode to be electrically insulated from the surrounding area. For that purpose the electrode is covered with an insulating sleeve. It has now been found that liquid medium can diffuse through that insulating sleeve. Relatively small amounts of liquid medium therefore accumulate between the electrode and the insulating sleeve.

If the pressure in the container in which the filling height of the liquid medium is to be measured falls below the vapor pressure of the liquid medium, the liquid medium between the insulating sleeve and the electrode abruptly vaporises and in that situation builds up a considerable pressure between the electrode and the insulating sleeve. That can result in the insulating sleeve being damaged or even destroyed.

DE 30 26 342 discloses a capacitive level probe, the electrode of which has at the center a passage which extends in the longitudinal direction and which is connected by way of radial branch passages to the region between the insulating sleeve and the outside surface of the electrode. Liquid medium diffuses into the intermediate space between the insulating sleeve and the electrode and further diffuses through that passage and out of the container so that the above-indicated damage effects cannot occur.

A disadvantage with a level probe of that kind is that the passage provides a communication between the interior of the container in which the liquid medium whose filling level is to be measured is disposed, and the space outside the container. The high manufacturing expenditure is also a disadvantage as the electrode is internally hollow and has to be constructed with branch passages.

The object of the present invention is to overcome disadvantages in the state of the art.

The invention attains that object by a capacitive level probe of the general kind set forth, in which the insulating sleeve is so designed that the flow path extends (i) through at least one opening in the insulating sleeve or (ii) completely between the electrode and the insulating sleeve.

The invention further attains the specified object by a container for liquid medium which includes a capacitive level probe of that kind.

In that respect the term flow path is used to denote the route that a gas bubble follows from the region between the insulating sleeve and the electrode into the area surrounding the level probe. Therefore there can be different routes for the gas bubble depending on where the gas bubble is respectively disposed. A level probe according to the invention is therefore in particular a level probe of the general kind set forth, in which all gas bubbles, irrespective of the location in the contact region at which they occur, flow through at least one opening in the insulating sleeve or completely between the electrode and the insulating sleeve, before they escape into the surrounding atmosphere.

An opening in the insulating sleeve is present if the flow path always extends in immediately adjacent relationship to the insulating sleeve and then through it. An opening in the insulating sleeve is not present for example when the insulating sleeve surrounds the electrode completely in a condition of bearing thereagainst but the electrode itself is hollow and the flow path extends through the hollow electrode. An opening can be for example a slot or a hole in the insulating sleeve.

If the capacitive level probe is fitted to a container in such a way that the electrode projects into the container and if the pressure in the container abruptly falls below the vapor pressure of the liquid medium, a gas bubble which is produced can flow along in the intermediate space between the electrode and the insulating sleeve and passes into the container, possibly through an opening in the insulating sleeve. That affords the advantage that the gas bubble does not pass out of the container.

A capacitive level probe of that kind is also easy to manufacture and thus inexpensive.

Preferably the connection portion is so designed that the level probe can be fixed to a wall in such a way that the sensor element is disposed on one side of the wall and the insulating sleeve is so designed that the flow path in the installation position of the level probe opens on that side of the wall into the area surrounding the level probe.

Preferably the opening in the insulating sleeve is arranged beyond the connection portion on the same side as the sensor element. That provides that the level probe can be pressure-tightly fixed in a container. In the event of damage to the insulating sleeve in that way no liquid medium can issue from the container. That is advantageous if the liquid medium for example is toxic. Conversely it is also not possible for substances to pass into the container, which is advantageous for example if the interior of the container is to remain sterile.

Preferably the electrode is surrounded with an insulating sleeve only in a portion which projects beyond the connection portion. In that case at least the sensor element is surrounded by the insulating sleeve. That ensures that there is no short-circuit with the liquid medium. The insulating sleeve however does not need to project substantially beyond the sensor element. In that way a portion (which is electrically insulated in relation to the sensor element) of the electrode and the insulating sleeve can remain free. Then, at the location at which the insulating sleeve ends, a gas bubble can issue from the intermediate space between the insulating sleeve and the electrode.

Preferably the insulating sleeve is tubular. An insulating sleeve of that kind is easy to produce, which leads to low manufacturing costs.

Preferably the opening is provided in a portion of the insulating sleeve, that is towards the connection portion. That is advantageous for the situation where the level probe projects substantially from above into the container in which the liquid medium whose filling level is to be measured is disposed. In such a situation, at the maximum filling level, the electrode is substantially surrounded by liquid medium.

Alternatively the opening can be provided in a portion of the insulating sleeve, that is remote from the connection portion. A level probe of that kind is advantageously used when the level probe is to be fitted to a container from below so that the electrode projects upwardly. In that case, when the liquid medium is at a low filling level, the portion of the insulating sleeve, that is towards the connection portion, is firstly wetted with liquid medium. In both cases it is desirable to provide the opening in such a way that, when there is no filling level, liquid medium is in the region of the insulating sleeve in which the opening is disposed.

Preferably the insulating sleeve contains polytetrafluoroethylene, particularly preferably consists of polytetrafluoroethylene. Polytetrafluoroethylene is also known by the name ‘Teflon’ and has excellent resistance to corrosion. In addition dirt substances are scarcely deposited at Teflon surfaces so that the risk of contamination and soiling of the insulating sleeve is low. In addition polytetrafluoroethylene is substantially impervious to most liquid media so that only small amounts of liquid medium can diffuse through the insulating sleeve.

Preferably the insulating sleeve bears over its entire length against the sensor element.

Preferably the sensor element is formed as a straight metal bar or straight metal tube. That affords particularly simple manufacture, thus in turn affording cost advantages.

In a preferred embodiment the insulating sleeve has at least one slot. A slot is produced if the material of the insulating sleeve is cut open at a spacing from an edge of the insulating sleeve, without the material being removed. A slot can be straight or non-straight. Preferably the slot is a straight slot.

It is preferred if the slot is present at a location which in the installation position of the level probe does not come into contact with the liquid medium. That ensures that no liquid medium can pass through the slot into the space between the insulating sleeve and the electrode. Particularly when the liquid medium is electrically non-conducting it is however also possible to provide the slot at a location on the insulating sleeve, which in the installation position of the level probe comes into contact with liquid medium.

Particularly preferably the capacitive level probe has a closure comprising: an outer casing element which is of an inside diameter which in a first portion that is towards the electrode is larger than the outside diameter of the electrode surrounded by the insulating sleeve by such an amount that a clearance fit is formed and increases in a second portion that adjoins the first portion, and an inner casing element which is at least partially arranged in the outer casing element and the inside diameter of which is larger than the outside diameter of the electrode so that a clearance fit is formed between the inner casing element and the electrode, and the outside diameter of which at a first side that is towards the first portion of the outer casing element is smaller than the inside diameter of the outer casing element, and the outside diameter thereof increases towards an oppositely disposed second side and is smaller on the opposite second side than the maximum inside diameter of the outer casing element, wherein the inner casing element is provided with a male screwthread and can be screwed into the outer casing element also provided with a female screwthread, in such a way that an insulating sleeve disposed between the inner and the outer casing elements is clamped and the inner casing element is pressed on to the electrode.

An advantage here is that the closure releases the insulating sleeve which is clamped between the inner and outer casing elements by the inner and outer casing elements being screwed out of each other so that the casing elements can be withdrawn from the sensor element of the electrode. The sensor element and the insulating sleeve can then be shortened, for example sawn off. The closure is then fluid-tightly fitted in place again and fixed in position. That makes it possible for the sensor element to be shortened at any time if that is necessary. By virtue of that design configuration it is sufficient to only produce capacitance probes with one electrode or sensor element length as the user can establish the ideal length himself. That affords reduced storage and simplified manufacture.

Preferably the level probe has measuring means for measuring the capacitance of the electrode in relation to a counterpart electrode, in particular in relation to a container. Advantageously in that arrangement the counterpart electrode is spaced from that electrode and is electrically insulated in relation to that electrode.

Preferably the counterpart electrode is in the shape of a hollow cylinder and is arranged concentrically with respect to the electrode.

In an advantageous configuration there is provided a further insulating protective sleeve which radially completely surrounds the electrode including the insulating sleeve. Such a further protective sleeve also itself has electrically insulating properties and as a result can increase a parallel resistance which occurs undesirably upon capacitive measurement in parallel with the capacitance. Conductivity between the electrode and the counterpart electrode is basically caused only by the medium. The insulating sleeve and also the protective sleeve are intended to counteract that conductivity and provide for a parallel resistance which is as high as possible. The increase in parallel resistance can thus be achieved on the one hand by the greater thickness which is caused by the mutually superposed insulating sleeve and protective sleeve. On the other hand in the case involving minor leakages towards the electrode, the paths for any leakage current are longer and thus there is a higher parallel resistance as any leakage current must additionally flow between the insulating sleeve and the protective sleeve in order to pass from the electrode to the counterpart electrode.

In addition mechanical reinforcement can also be achieved by the additional protective sleeve. On the one hand mechanical loadings from the exterior in relation to the insulating sleeve are warded off by the protective sleeve. On the other hand the additional protective sleeve also reinforces the insulating sleeve for the situation where a gas bubble is formed between the electrode and the insulating sleeve. Outward curvature of the insulating sleeve which occurs temporarily due to such a gas bubble can thus be kept at a low level by the additional protective sleeve in order to keep down the loading that this involves on the insulating sleeve and to promote discharge of the gas bubble through an opening.

Preferably for that purpose the protective sleeve bears closely against the insulating sleeve insofar as the protective sleeve surrounds the insulating sleeve. That close contact prevents an intermediate space between the insulating sleeve and the protective sleeve and thereby reduces to a minimum, the penetration of the medium in between the insulating sleeve and the protective sleeve. The protective sleeve can extend in the axial direction over regions in which there is no insulating sleeve so that the protective sleeve can also not bear closely against the insulating sleeve in those regions.

It is desirable if the protective sleeve extends in the axial direction from the end of the electrode, that is remote from the connection portion, or a or the closure arranged at said end of the electrode, approximately as far as an or the opening of the insulating sleeve. The fact that the protective sleeve extends from the closure means that a sealing integrity can also be achieved here between the closure and the protective sleeve. The protective sleeve should extend in the axial direction as far as possible to an opening in order to be able to make use of the advantages of the protective sleeve to the maximum possible extent. In that respect however the protective sleeve should not close the opening in the insulating sleeve and thus should only extend approximately to that opening.

In an advantageous configuration the capacitive level probe is characterised by a closure at the end of the electrode, that is remote from the connection portion, for preventing the medium from entering between the electrode and the insulating sleeve and/or the protective sleeve and said closure has an insulating casing which is fitted on the electrode end with a closed end face for insulating the electrode end in relation to the medium, and a fixing means for sealingly fixing the insulating sleeve and/or the protective sleeve to the insulating casing. The end of the electrode is insulated in relation to the medium by the insulating casing which is fitted on the electrode end and which has a closed end and which also radially encloses the end of the electrode. For sealing the electrode moreover it is only necessary for the insulating sleeve and/or the protective sleeve to be fixed to the insulating casing in sealing relationship, whereby the electrode overall is sealed off in relation to the medium, at any event if the insulating sleeve or the protective sleeve extends towards the connection portion.

The insulating casing can be easily fixed to the end of the electrode, such as for example by a groove-and-tongue connection. The insulating casing could therefore have for example an inwardly facing projection such as a tongue which, when the insulating casing is pushed on, latches in positively locking engagement into a recess such as for example a groove. When shortening the electrode, such a recess can be easily provided at the new location.

Desirably the fixing means is in the form of a clamping means, in particular in the form of a spring. Sealing fixing can thus be achieved by bracing, whereby it is possible to afford a simple and in that respect releasable connection.

In a variant the insulation casing can be formed integrally with the protective sleeve. The protective sleeve together with the insulating casing thus forms a substantially tubular body which is closed at one end and which can be pushed over the electrode and the insulating sleeve from the end that is remote from the connection portion.

In a particularly desirable configuration the closure is characterised in that the insulating casing is substantially of an outside diameter corresponding to the insulating sleeve, the protective sleeve radially closely embraces the insulating casing and extends axially to over at least a part of the insulating sleeve, and a coil spring encloses the protective sleeve in the region of the insulating casing in order to press the protective sleeve in sealing relationship against the insulating casing. In that case a closure can be fitted in a simple fashion if the electrode has an insulating sleeve from which its end projects a little. It is only necessary firstly for the insulating casing to be pushed on to the electrode end. With the insulating casing and the insulating sleeve being of the same outside diameter, that therefore affords a uniform outside diameter possibly with the exception of an intermediate space in the axial direction. Accordingly a common protective sleeve can be pushed over the insulating casing and the insulating sleeve. The sleeve bears closely and in sealing relationship both around the insulating sleeve and also around the insulating casing. For additionally fixing the protective sleeve to the insulating casing a coil spring is arranged in a simple fashion over the protective sleeve in that region. There is no need to support the fixing of the protective sleeve on the insulating sleeve as the two sleeves have a long contact region in the axial direction, which affords an adequate holding effect. Moreover an at least minor movement should also be possible between the two sleeves in order thereby to avoid for example stressing effects.

Such a closure can be achieved in a simple fashion and thus also inexpensively. The use of only a few elements also prevents stressing of the elements in relation to each other. Such stresses can easily occur precisely in uses involving large fluctuations in temperature. Particularly when elements are very rigidly connected together, such stresses easily result in fatigue phenomena, which for example can entail leakages.

The invention is described in greater detail hereinafter with reference to the drawing in which:

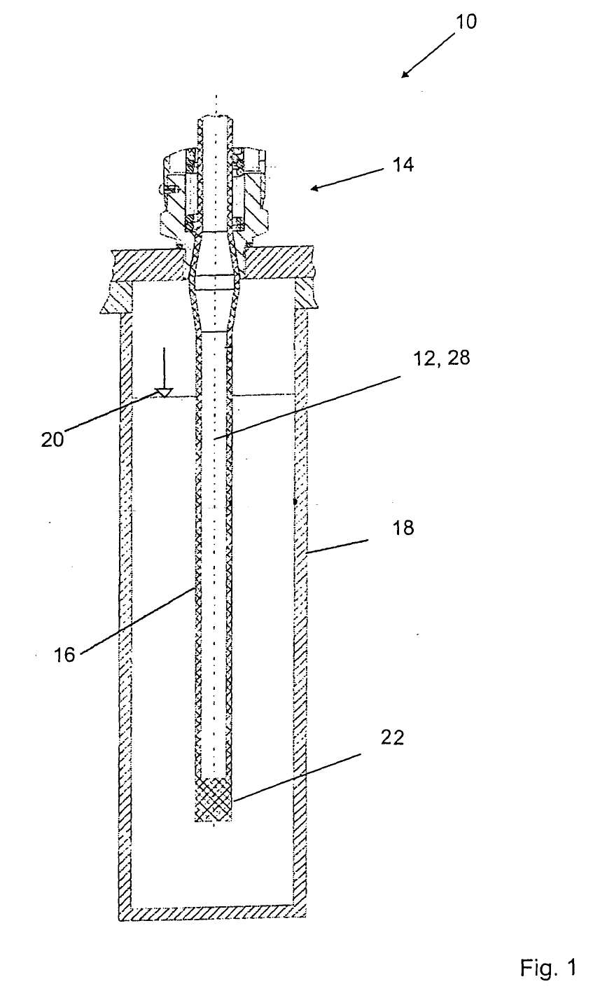

FIG. 1 shows a level probe in accordance with the state of the art,

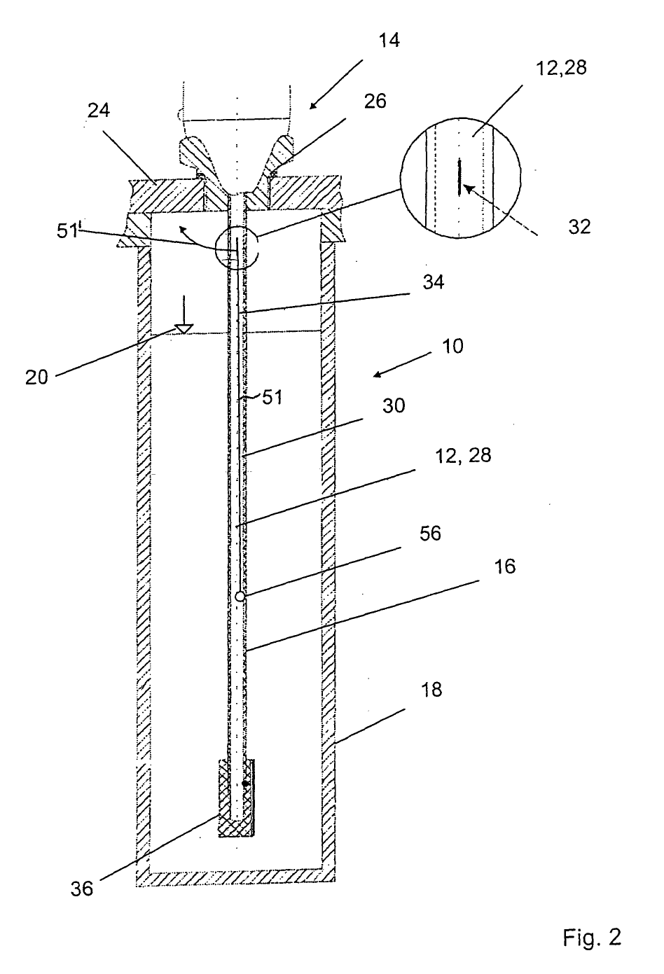

FIG. 2 shows a level probe according to the invention in cross-section,

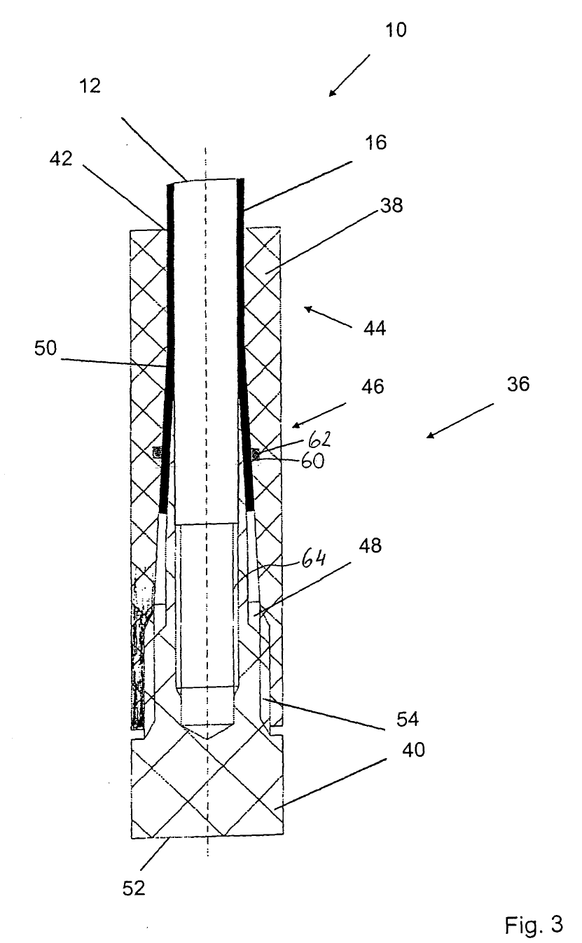

FIG. 3 shows a closure of a level probe according to the invention as shown in FIG. 2 in cross-section,

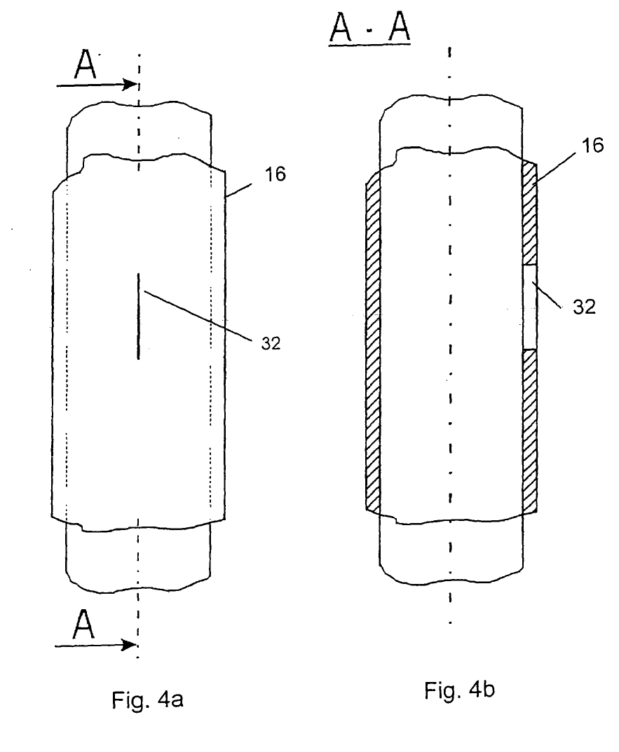

FIG. 4a shows a diagrammatic front view of a slot in a level probe according to the invention,

FIG. 4b shows a diagrammatic view of the slot of FIG. 4a along section line A-A,

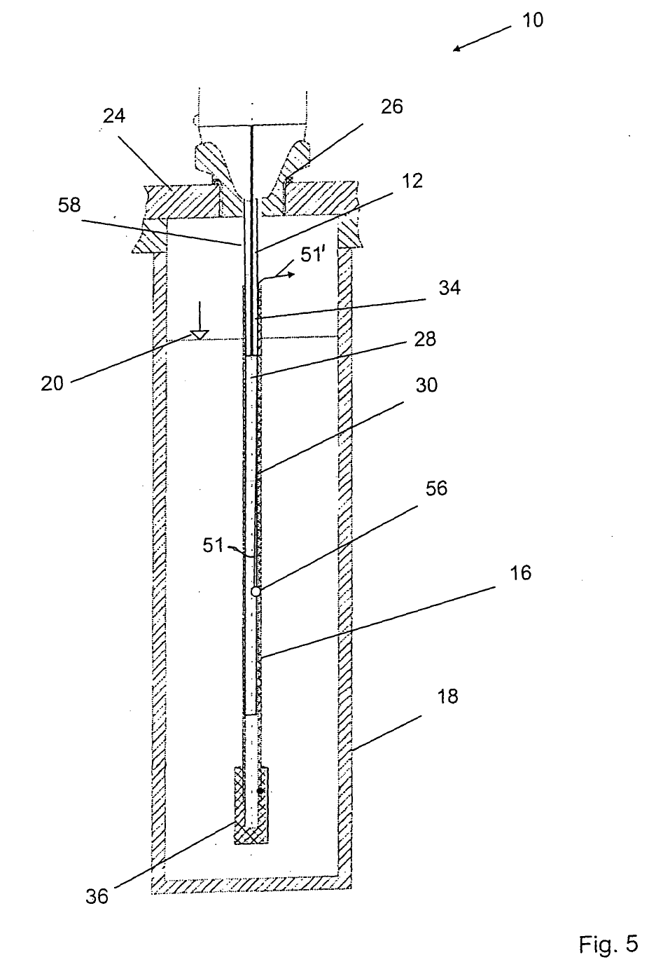

FIG. 5 shows a further embodiment of a level probe according to the invention,

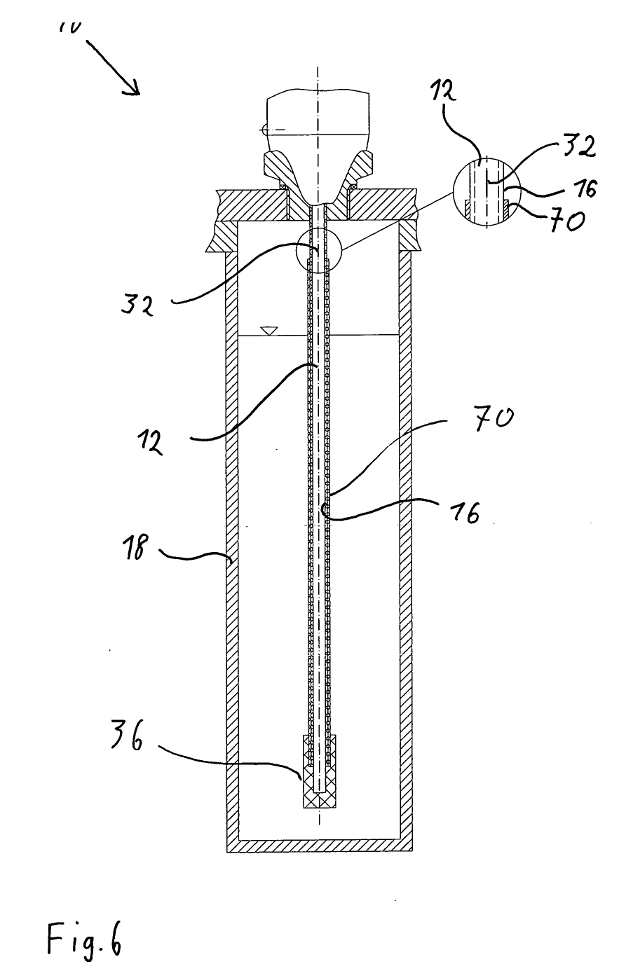

FIG. 6 shows a level probe according to the invention as in FIG. 2 but with an additional protective sleeve,

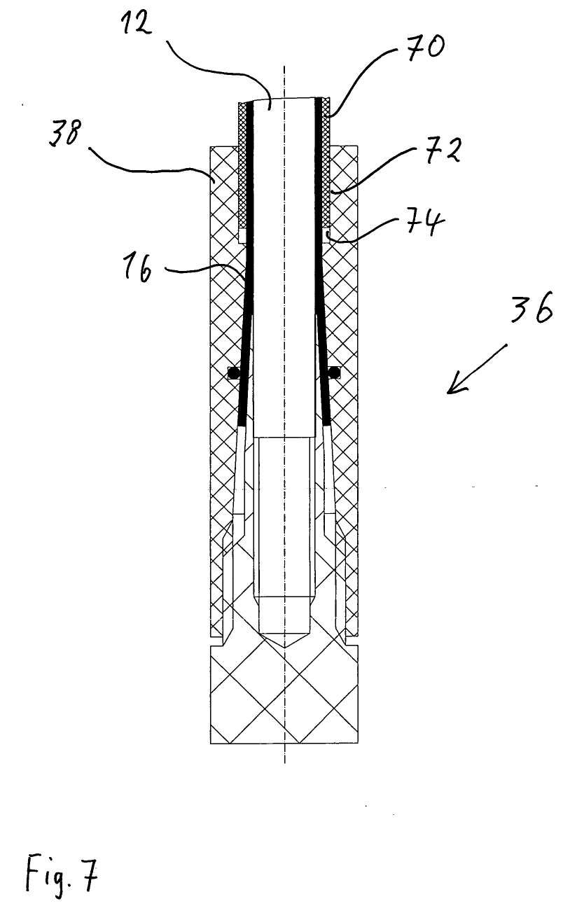

FIG. 7 shows a closure as in FIG. 3 but with an additional protective sleeve, and

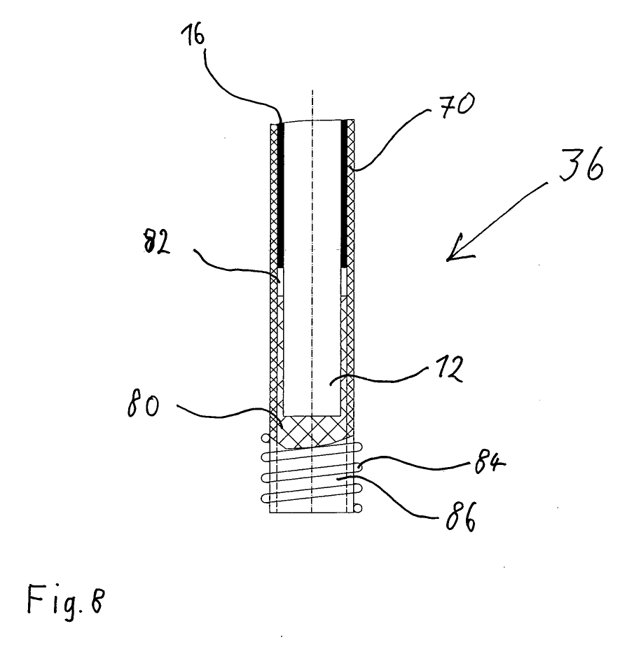

FIG. 8 shows a closure in accordance with a further embodiment of the invention as a partly sectional side view.

FIG. 1 shows a level probe 10 in accordance with the state of the art. The level probe includes an electrode 12, a connection portion 14 and an insulating sleeve 16. The electrode 12 projects into a container 18 in which there is a liquid medium (not shown), the filling height of which is to be determined. The level of the liquid medium at the maximum filling height is represented by an arrow 20. The electrode 12 comprises a substantially cylindrical metal tube which is radially completely surrounded by the insulating sleeve 16.

At the lowest location, that is to say where wetting with fluid ends last as the filling height falls, the insulating sleeve 16 is welded to a closure portion 22 in such a way that the insulating sleeve 16 is pressure-tight.

The insulation 16 extends partially around the connection portion 14 and substantially completely surrounds the electrode 12.

FIG. 2 shows a level probe 10 according to the invention. The connection portion 14 is adapted to fix the level probe 10 to a wall 24. For that purpose the connection portion 14 has a male screwthread which engages into a female screwthread in the wall 24. The wall 24 and the connection portion 14 are sealed off relative to each other by way of a metal sealing ring 26 or another kind of seal.

In the level probe 10 shown in FIG. 2 the electrode 12 is in the form of a sensor element 28 which is radially completely surrounded by the insulating sleeve 16. In this case the insulating sleeve 16 which is of a tubular configuration bears against the electrode 12 in a contact region 30. The contact region 30 is the region in which the insulating sleeve 16 and the electrode 12 are in contact with each other, here therefore being the surface of the substantially cylindrical electrode 12.

A slot 32 is provided in the insulating sleeve 16 beyond the connection portion 14, on the same side as the sensor element 28. The slot 32 is shown on an enlarged scale in FIG. 2. The slot 32 is disposed in a portion 34, that is towards the connection portion 14, of the insulating sleeve 16, outside the measuring region which extends to just beneath the slot 32.

Arranged at the end of the electrode 12, that is spaced from the connection portion 14, is a closure 36 which seals off the insulating sleeve 16 at that location to prevent the ingress of liquid medium.

FIG. 3 shows a diagrammatic view on an enlarged scale of the closure 36. The closure 36 comprises an outer casing element 38 and an inner casing element 40. The outer casing element 38 has a longitudinal bore 42 in a first portion 44 which is towards the electrode. In the first portion 44, the inside diameter of the outer casing element 38 is a small amount larger than the outside diameter of the insulating sleeve 16 so that the outer casing element 38 is displaceable along the electrode 12 which is provided with the insulating sleeve 16.

Adjoining the first portion 44 is a second portion 46. The inside diameter of the outer casing element 38 increases in that second portion 46. The outer casing element 38 has a female screwthread 48 at the outermost end of the second portion 46.

The inner casing element 40 projects into the outer casing element 38 so that the side that is towards the connection portion 14 (not shown in FIG. 3) adjoins the first portion 44 of the outer casing element 38. The inner casing element 40 has a blind hole with a female screwthread so that the inner casing element 40 can be connected or screwed to a male screwthread provided on the electrode 12.

The outside diameter of the inner casing element 40 progressively increases from a first side 50 which is towards the connection portion 14 (not shown in FIG. 3), to an oppositely disposed second side 52, thus affording a conical outside surface. In the portion adjoining the second side 52 the inner casing element 40 has a male screwthread 54 co-operating with the female screwthread 48 of the outer casing element 38.

The insulating sleeve 16 is clamped between the conical portion which is adjacent to the first side 50 of the inner casing element 40 and the second portion 46 of the outer casing element 38, when the two casing elements 38, 40 are braced against each other by way of the female screwthread 48 and the male screwthread 54 respectively. In addition, the pressure which the outer casing element 38 applies to the inner casing element 40 provides that the closure 36 as a whole is pressed on to the electrode 12 so that the electrode 12 and the closure 36 are immovable relative to each other.

In a particular embodiment, provided at the inner, conical wall of the outer casing element 38, in the region of the conical portion of the inner casing element 40, is a radially peripherally extending groove 60 carrying an O-ring 62. That O-ring 62 is thus disposed at a location at which the insulating sleeve 16 is clamped in position. That provides an additional sealing effect. In order to shorten the electrode 12 the outer casing element 38 and the inner casing element 40 are released from each other and withdrawn from the electrode 12. The electrode can then be sawn off and the closure re-fitted.

In a further embodiment, also provided on the electrode 12 is a male screwthread 64 which can be screwed to the female screwthread of the casing element 40. For the purposes of shortening, the screwthread can be of any desired length. Advantageously the screwthread 64 extends into the region of the upper end of the electrode.

FIGS. 4a and 4b show diagrammatic views of the slot 32. FIG. 4b is a section taken along section line A-A in FIG. 4 and shows how the material of the insulating sleeve 16 is cut open, thereby forming the slot 32. As FIG. 4a shows, the material of the insulating sleeve 16 is however only cut open in the region of the slot, and material is not removed.

If a gas bubble 56 is produced due to a drop in pressure in the container 18 in the contact region 30 (see FIG. 2) it flows in the contact region 30 along a flow path 51 which is shown as ending in a curved arrow 51′, to the slot 32 and passes therethrough into the area surrounding the electrode 12, that is to say the level probe 10. Irrespective of where the gas bubble 56 occurs, the gas always flows between the electrode 12 and the insulating sleeve 16, namely in the contact region 30, or through an opening, namely through the slot 32 in the insulating sleeve 16.

FIG. 5 shows a further embodiment of a level probe 10 according to the invention. In this case the electrode 12 includes the sensor element 28 and in part in the region of the electrode which does not belong to the sensor element 28. An unsheathed or free portion 58 of the electrode 12 is therefore not radially enclosed by the insulating sleeve 16. A gas bubble 56 to be found between the electrode 12 and the insulating sleeve 16 flows upon a drop in pressure in the contact region 30 between the electrode 12 and the insulating sleeve 16 until it can issue from the insulating sleeve 16 at the boundary with the portion 58. In this case the flow path 51 (once again shown as ending with a curved arrow 51′) extends completely between the insulating sleeve 16 and the electrode 12 but not through an opening in the insulating sleeve.

To measure the capacitance of the electrode in relation to the surrounding area the sensor element 28 is connected to a measuring means (not shown here). In that respect the container 18 acts as a counterpart electrode.

Hereinafter similar elements and also functionally similar elements are in part denoted by identical references.

Referring to FIG. 6 the capacitive level probe 10 has an additional protective sleeve 70 which extends substantially from the closure 36 to the slot 32 without however touching the latter. In this case the protective sleeve 70 is in the form of a cylindrical tube which bears closely against the insulating sleeve 16. The protective sleeve 70 is also passed into the closure 36 for closure purposes. It is to be noted that the closure 36 is only diagrammatically illustrated here. It can involve various design forms with the configuration of the capacitive level probe 10 otherwise being the same.

By virtue of its closely embracing relationship the protective sleeve 70 stabilises the insulating sleeve 16 and increases the electrical parallel resistance which occurs between the electrode 12 and the wall of the container 18 as the counterpart electrode.

In the embodiment of the closure 36 shown in FIG. 7 the protective sleeve 70 is inserted into a cylindrical recess 72 which is formed between the insulating sleeve 16 and the outer casing element 38. The protective sleeve 70 is inserted into that recess 72 as a firm fit between the insulating sleeve 16 and the outer casing body 38. That makes it possible to provide a sealing connection, in which respect the demands on such a sealing effect are less than on the sealing effect in respect of the insulating sleeve 16 in relation to the closure 36 and in relation to the electrode 12. The reason for this is that the protective sleeve 70 does not bear directly against the electrode 12. The protective sleeve 70 does not completely fill the recess 72 so that an intermediate space 74 remains. Such an intermediate space 74 is advantageous in order to provide a compensation option in respect of movements which occur by virtue of thermally induced or other movements of the elements relative to each other.

The closure 36 in accordance with a further embodiment of the invention also makes use of the protective sleeve 70, as can be seen from FIG. 8. Pushed on to an end of the electrode 12 is an insulating casing 80 which in this case approximately forms a cap for the electrode 12. The insulating casing 80 is of the same outside diameter as the insulating sleeve 16. The insulating casing 80 and the insulating sleeve 16 thus form a common cylindrical outside peripheral surface of the same outside diameter around the electrode 12. That outside peripheral surface however is interrupted in the region of a casing intermediate space 82 in order in particular to permit thermal compensating movements as between the elements.

The protective sleeve 70 is pushed in closely bearing relationship over that common cylindrical peripheral surface formed by the insulating sleeve 16 and the insulating casing 80. In order to achieve sealing integrity between the protective sleeve 70 and the insulating casing 80, a coil spring 84 surrounds the protective sleeve 70 and thereby presses it against an end portion 86 of the insulating casing 80. The insulating casing 80 is in the form of a solid cylinder in that end region. The pressure exerted by the coil spring 84 therefore does not act directly on the electrode 12. Sealing integrity can thus be achieved between the protective sleeve 70 and the insulating casing 80 without exerting pressure on the electrode 12. Finally, sealing integrity to prevent medium from entering a region between the electrode 12 and the insulating sleeve 16 is achieved by the protective sleeve 70 bearing closely around the insulating sleeve 16.

Fixing of the insulating sleeve 80 to the electrode 12 can be achieved by a large number of possible options such as for example the provision of a recess in the electrode at its periphery and a corresponding projection in that region on the insulating casing 80. Such a fixing or another fixing is however not visibly shown in FIG. 8.

1. A capacitive level probe, for measuring the filling height of an in particular liquid medium, comprising:
a connection portion,
an electrode which is connected to the connection portion and which projects beyond the connection portion and which includes a sensor element,
an insulating sleeve for insulating the level probe in relation to the medium, the insulating sleeve radially completely surrounding the sensor element,
wherein the insulating sleeve bears against the electrode in a contact region, and
wherein the electrode and the insulating sleeve are so designed that gas present in the contact region flows out of the contact region on a flow path out of the contact region upon a pressure drop between the contact region and the area surrounding the level probe,
characterised in that
the insulating sleeve is so designed that the flow path extends
(i) through at least one opening in the insulating sleeve or
(ii) completely between the electrode and the insulating sleeve.

2. A capacitive level probe as set forth in claim 1 wherein the connection portion is so designed that the level probe can be fixed to a wall in such a way that the sensor element is disposed on one side of the wall and the insulating sleeve is so designed that the flow path in the installation position of the level probe opens on that side of the wall into the area surrounding the level probe.

3. A capacitive level probe as set forth in claim 1 wherein the opening in the insulating sleeve is arranged beyond the connection portion on the same side as the sensor element.

4. A capacitive level probe as set forth in claim 1 wherein the electrode is surrounded with an insulating sleeve only in a portion which projects beyond the connection portion.

5. A capacitive level probe as set forth in claim 1 wherein the insulating sleeve is tubular.

6. A capacitive level probe as set forth in claim 1 wherein the opening is provided in a portion of the insulating sleeve, that is towards the connection portion.

7. A capacitive level probe as set forth in claim 1 wherein the insulating sleeve contains polytetrafluoroethylene.

8. A capacitive level probe as set forth in claim 1 wherein the insulating sleeve bears over its entire length against the sensor element.

9. A capacitive level probe as set forth in claim 1 wherein the sensor element is formed as a straight metal bar or straight metal tube.

10. A capacitive level probe as set forth in claim 1 wherein the insulating sleeve has at least one slot.

11. A capacitive level probe as set forth in claim 10 wherein the slot is present at a location which in an installation position of the level probe does not come into contact with the liquid medium.

12. A capacitive level probe as set forth in claim 1 further including a closure comprising:
an outer casing element which is of an inside diameter which in a first portion that is towards the electrode is larger than the outside diameter of the electrode surrounded by the insulating sleeve by such an amount that a clearance fit is formed and which increases in a second portion that adjoins the first portion, and
an inner casing element which is at least partially arranged in the outer casing element and the inside diameter of which is larger than the outside diameter of the electrode so that a clearance fit is formed between the inner casing element and the electrode, and
the outside diameter of which at a first side that is towards the first portion of the outer casing element is smaller than the inside diameter of the outer casing element, and
the outside diameter thereof increases towards an oppositely disposed second side,
wherein the inner casing element is provided with a male screwthread and can be screwed into the outer casing element provided with a female screwthread, in such a way that an insulating sleeve disposed between the inner and the outer casing elements is clamped and the inner casing element is pressed on to the electrode.

13. A capacitive level probe as set forth in claim 1 further comprising a measuring means for measuring the capacitance of the electrode in relation to a counterpart electrode, in particular in relation to a container.

14. A capacitive level probe as set forth in claim 13 wherein the counterpart electrode is spaced from the electrode and is electrically insulated in relation to that electrode.

15. A capacitive level probe as set forth in claim 14 wherein the counterpart electrode is in the shape of a hollow cylinder and is arranged concentrically with respect to the electrode.

16. A capacitive level probe as set forth in claim 1 wherein a further insulating protective sleeve radially completely surrounds the electrode including the insulating sleeve.

17. A capacitive level probe as set forth in claim 16 wherein the protective sleeve bears closely against the insulating sleeve insofar as the protective sleeve surrounds the insulating sleeve.

18. A capacitive level probe as set forth in claim 16 wherein the protective sleeve extends in the axial direction from the end of the electrode, that is remote from the connection portion, or the closure arranged at said end of the electrode, approximately as far as the opening of the insulating sleeve.

19. A capacitive level probe as set forth in claim 1 further comprising a closure at the end of the electrode, that is remote from the connection portion, for preventing the medium from entering between the electrode and the insulating sleeve and/or the protective sleeve, comprising:
an insulating casing which is fitted on the electrode end with a closed end face for insulating the electrode end in relation to the medium, and
a fixing means for sealingly fixing the insulating sleeve and/or the protective sleeve to the insulating casing.

20. A capacitive level probe as set forth in claim 19 wherein the fixing means is in the form of a spring.

21. A capacitive level probe as set forth in claim 19 wherein the insulating casing is formed integrally with the protective sleeve.

22. A capacitive level probe as set forth in claim 19, wherein
the insulating casing is substantially of an outside diameter corresponding to the insulating sleeve,
the protective sleeve radially closely embraces the insulating casing and extends axially to over at least a part of the insulating sleeve, and
a coil spring encloses the protective sleeve in the region of the insulating casing in order to press the protective sleeve in sealing relationship against the insulating casing.

23. A container for liquid medium including a capacitive level probe as set forth in claim 1.

24. A capacitive level probe as set forth in claim 1 wherein the insulating sleeve consists of polytetrafluoroethylene.

25. A capacitive level probe as set forth in claim 17 wherein the protective sleeve extends in the axial direction from the end of the electrode, that is remote from the connection portion, or the closure arranged at said end of the electrode, approximately as far as the opening of the insulating sleeve.

26. A capacitive level probe as set forth in claim 20 wherein the insulating casing is formed integrally with the protective sleeve.
